(19) United States
(12) Patent Application Publication
(10) Pub. No.: US 2026/0225500 A1
(43) Pub. Date: Aug. 6, 2026

(54) VEHICLE SEAT RAIL DEVICE

(71) Applicant: HYUNDAI TRANSYS INC., Seosan-si (KR)

(72) Inventor: Cheon KIM, Hwaseong-si (KR)

(21) Appl. No.: 19/421,624

(22) Filed: Dec. 16, 2025

(30) Foreign Application Priority Data
Jan. 6, 2025 (KR) 10-2025-0001679

(51) Int. Cl. B60N 2/07

(52) U.S. Cl. CPC B60N 2/0722

(57) ABSTRACT

A vehicle seat rail device is configured to prevent occurrence of clearance in a long rail for forward-and-rearward movement of a seat and to improve operating force of the long rail, wherein the vehicle seat rail device is configured such that, as a vertical clearance control function of an upper bearing, the upper bearing is kept in close contact with an upper plate of a lower rail and is movable along the upper plate regardless of load applied to the lower rail via an upper rail when a passenger sits on the seat and dimensional deviation of the lower rail, thereby making it possible not only to eliminate a difference between operating force for forward movement of the seat and operating force for rearward movement of the seat, but also to maximally increase satisfaction of the passenger sitting on the seat through control of forward-and-rearward movement of the seat.

### CROSS-REFERENCE TO RELATED APPLICATION

This application claims priority, under 35 U.S.C. § 119(a), from Korean Patent Application No. 10-2025-0001679, filed on Jan. 6, 2025, the entire contents of which are incorporated herein by reference.

### BACKGROUND

### (a) Technical Field

The present disclosure relates to a vehicle seat rail device, and more particularly, to a vehicle seat rail device configured to prevent occurrence of clearance in a long rail for forward-and-rearward movement of a seat and to improve operating force of the long rail.

### (b) Background Art

Generally, a vehicle seat includes a seat cushion configured for the lower body of a passenger to be seated thereon, a seatback against which the upper body of a passenger leans, and a headrest configured to support the neck and head of a passenger. Here, the vehicle seat is mounted on a floor panel in the vehicle interior with a seat rail interposed between the vehicle seat and the floor panel, so that the position of the vehicle seat is adjustable in the forward-and-rearward direction.

Recently, in order to provide convenience such as moving the seat to a desired position in the vehicle interior or automatically moving the seat to a position allowing a passenger to easily enter or exit a vehicle, a power long rail has been employed to increase movement stroke of the seat.

A conventional long rail device includes a lower rail provided as a long rail having a predetermined length and mounted on a floor panel, an upper rail movably connected to the lower rail, and a moving device mounted on the upper rail to move the upper rail along the lower rail. The moving device includes an upper bearing and a lower bearing that are movably supported by upper and lower plates of the lower rail.

The upper bearing has a function of controlling clearance of the upper plate of the lower rail. In this case, the upper bearing needs to be kept in close contact with the upper plate of the lower rail in a movable manner regardless of load applied to the lower rail through the upper rail when a passenger sits on the seat and any dimensional deviation of the lower rail.

However, in the case of conventional long-rail devices, the load applied to the lower rail and the dimensional deviation of the lower rail when the seat is moved forwards or rearwards may hinder smooth rolling of the upper bearing, leading to a difference between operating force for forward movement of the seat and operating force for rearward movement of the seat. As a result, the passenger sitting on the seat may not be satisfied with forward-and-rearward movement of the seat due to deterioration in forward-and-rearward movement performance of the seat.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an aspect of the present disclosure to provide a vehicle seat rail device configured such that, as a vertical clearance control function of an upper bearing, the upper bearing is kept in close contact with an upper plate of a lower rail and is movable along the upper plate regardless of load applied to the lower rail via an upper rail when a passenger sits on a seat and dimensional deviation of the lower rail, thereby making it possible not only to eliminate a difference between operating force for forward movement of the seat and operating force for rearward movement of the seat, but also to maximally increase satisfaction of the passenger sitting on the seat through reliable control of forward-and-rearward movement of the seat.

In one aspect, the present disclosure provides a vehicle seat rail device including a lower rail having a lower plate and an upper plate integrally connected to each other, the lower plate and the upper plate forming a rail space, an upper rail movably arranged along the lower rail, the upper rail including a lower movable plate formed at a lower portion of the upper rail and arranged within the rail space, the lower movable plate having a pair of first inclined surfaces formed on an upper portion thereof, the first inclined surfaces formed on the upper portion spaced apart from each other, a lower bearing mounted on an outer surface of the lower movable plate and movably seated on the lower plate of the lower rail, a guide bracket including a pair of second inclined surfaces formed on an upper portion thereof, the second inclined surfaces formed spaced apart from each other, the guide bracket mounted on the outer surface of the lower movable plate, an upper bearing in close contact with the upper plate of the lower rail, the upper bearing being movable along the upper plate of the lower rail, a bearing guide pin coaxially installed in the upper bearing and including opposite ends configured to be seated on the first inclined surface and the second inclined surface, respectively, and restoring springs mounted inside the rail space, wherein the restoring springs are in close contact with the bearing guide pin and are configured to apply elastic pressure against the bearing guide pin.

In a preferred embodiment, the pair of first inclined surfaces formed on the lower movable plate and the pair of second inclined surfaces formed on the guide bracket may be formed to have the same inclination angle and the bearing guide pin is horizontally oriented by the pair of first inclined surfaces and the pair of second inclined surfaces.

In another preferred embodiment, the inclination angles of the first and second inclined surfaces may range from 5° to 6° to apply gravitational force on the bearing guide pin thereby preventing the bearing guide pin from being separated from the first and second inclined surfaces.

In still another preferred embodiment, one of the pair of first inclined surfaces formed on the lower movable plate may be formed to be inclined downwards toward a front side, and the other may be formed to be inclined downwards toward a rear side.

In yet another preferred embodiment, one of the pair of second inclined surfaces formed on the guide bracket may be formed to be inclined downwards toward a front side, and the other may be formed to be inclined downwards toward a rear side.

In still yet another preferred embodiment, a spring guide may be mounted in the rail space, and the restoring springs may be mounted on the spring guide so as to apply elastic pressure to the bearing guide pin and may be in close contact with the bearing guide pin.

In a further preferred embodiment, the spring guide may include an upper plate seated on upper surfaces of the lower movable plate and the guide bracket, and a side plate formed to extend downwards from opposite ends of the upper plate, wherein one of the opposite ends is coupled to the lower movable plate, and the other is coupled to the guide bracket.

In another further preferred embodiment, the side plate may include an elastic hook formed on a lower end thereof, the elastic hook configured to be inserted into and coupled to a coupling groove formed in a lower portion of the lower movable plate or be caught by and coupled to a bottom surface of the guide bracket.

In still another further preferred embodiment, the side plate may include an interference-preventing cutout portion configured to prevent interference between the spring guide and the bearing guide pin, respectively mounted on the first inclined surface and the second inclined surface.

In yet another further preferred embodiment, the spring guide may include a bearing exposure hole formed in the upper plate thereof, the bearing exposure hole configured to allow an upper end of the upper bearing to protrude and contact the upper plate of the lower rail.

In still yet another further preferred embodiment, each of the restoring springs may be a plate spring, wherein one end of the plate spring is connected to a spring pin fixed to the side plate of the spring guide on an inner surface thereof, and the other end of the plate spring is in close contact with the bearing guide pin to provide the elastic pressure to the bearing guide pin.

Other aspects and preferred embodiments of the disclosure are discussed infra.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., vehicles powered by fuels derived from resources other than petroleum). As referred to herein, a hybrid vehicle is a vehicle that has two or more sources of power, for example, a vehicle powered by both gasoline and electricity.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is an exploded perspective view of a vehicle seat rail device according to the present disclosure;

FIG. 2 is an assembled perspective view of the vehicle seat rail device according to the present disclosure;

FIG. 3 is a longitudinal cross-sectional view showing the assembled state of the vehicle seat rail device according to the present disclosure;

FIG. 4 is an enlarged side view of main portions of the vehicle seat rail device according to the present disclosure;

FIG. 5 is an enlarged side view of the main portions, showing an inclination angle of an inclined surface on which a bearing guide pin of the vehicle seat rail device according to the present disclosure is seated;

FIG. 6 is a perspective view of the main portions, showing a direction of elastic pressure applied by a restoring spring of the vehicle seat rail device according to the present disclosure; and

FIG. 7 is a schematic diagram illustrating the principle of setting the inclination angle of the inclined surface on which the bearing guide pin of the vehicle seat rail device according to the present disclosure is seated.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Specific structural or functional descriptions given in connection with the embodiments disclosed herein are merely illustrative for the purpose of describing embodiments according to the concept of the present disclosure, and the embodiments according to the concept of the present disclosure may be implemented in various forms. Further, the present disclosure should not be construed as being limited to the embodiments described herein, and it will be understood that the present disclosure is intended to cover not only the embodiments, but also various modifications, equivalents, and alternatives, which may be included within the spirit and technical scope of the present disclosure.

Meanwhile, in the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the disclosed embodiment.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, such as “between” and “directly between” or “adjacent to” and “directly adjacent to”, should be interpreted in the same manner.

The same reference numerals represent the same components throughout the specification. Additionally, the terms in the specification are used merely to describe embodiments and are not intended to limit the present disclosure. In this specification, an expression in a singular form also encompasses a plural form, unless clearly specified otherwise in context. As used herein, expressions such as “comprise” and/or “comprising” do not exclude the presence or addition of one or more components, steps, operations, and/or elements other than those described.

Hereinafter, preferred embodiments of the present disclosure will be described in detail with reference to the accompanying drawings.

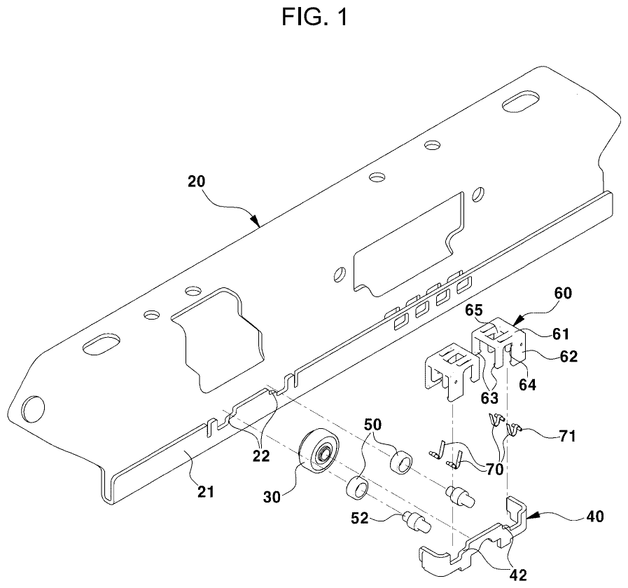

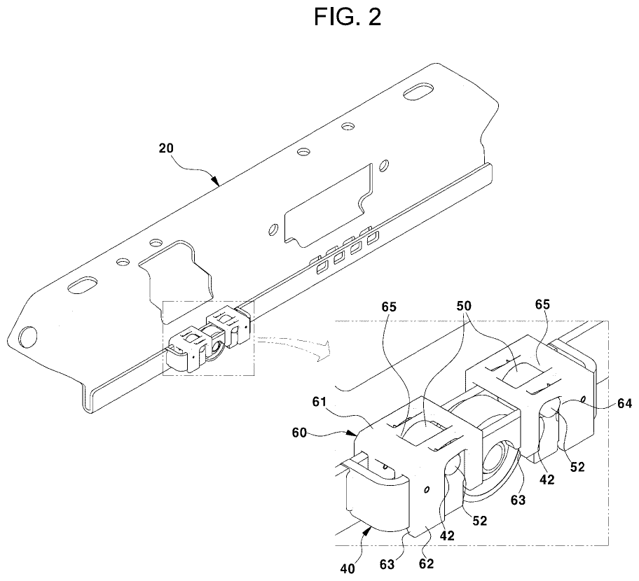

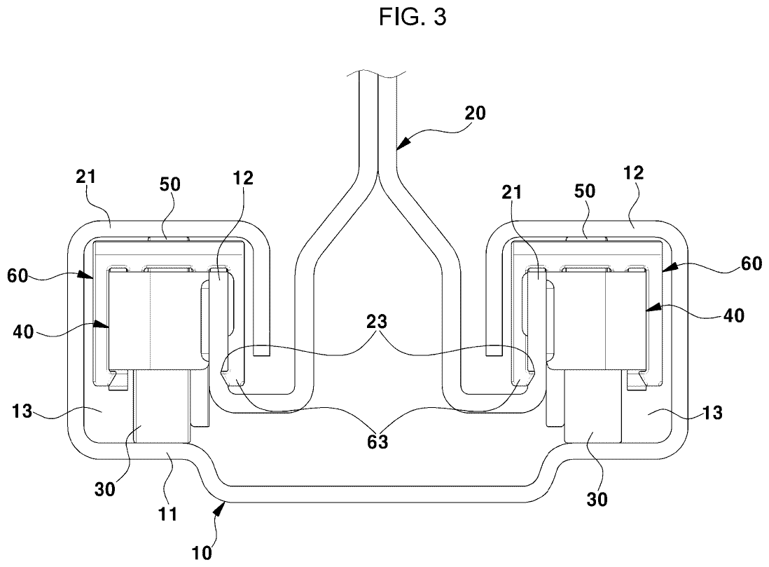

FIG. 1 is an exploded perspective view of a vehicle seat rail device according to the present disclosure, FIG. 2 is an assembled perspective view of the vehicle seat rail device according to the present disclosure, and FIG. 3 is an assembled cross-sectional view showing the vehicle seat rail device according to the present disclosure.

Referring to FIGS. 1, 2, and 3, a rail device according to the present disclosure includes a lower rail 10 provided as a long rail having a predetermined length and mounted on a floor panel, and an upper rail 20 coupled to the lower rail 10 and formed to be movable forwards and rearwards along the lower rail 10.

The lower rail 10 includes a lower plate 11 mounted on the floor panel (not shown), and an upper plate 12 integrally connected to both ends of the lower plate 11.

More specifically, as shown in FIG. 3, the upper plate 12 of the lower rail 10 is formed in such a manner that the upper plate 12 is vertically bent upwards from both ends of the lower plate 11, is horizontally bent inwards, and then is vertically bent downwards. In this manner, a rail space 13 for forward-and-rearward movement of the upper rail 20 is formed between the lower plate 11 and the upper plate 12.

The upper end of the upper rail 20 is connected to a frame portion (not shown) of a seat cushion on which the passenger sits, and the lower end thereof is arranged to be movable forwards and rearwards along the lower rail 10.

To this end, a lower movable plate 21 vertically bent outwards is formed to be integrated with a lower portion of the upper rail 20. The lower movable plate 21 may be inserted into and arranged in the rail space 13 so as to be movable forwards and rearwards.

In this case, a pair of first inclined surfaces 22 is formed at predetermined locations on the upper surface of the lower movable plate 21. Here, the inclined surfaces 22 are spaced apart from each other in the forward-and-rearward direction.

A lower bearing 30 is mounted on the outer surface of the lower movable plate 21 and is located between the pair of first inclined surfaces 22. The lower bearing 30 is slidably seated on the lower plate 11 of the lower rail 10.

A guide bracket 40 is mounted on the outer surface of the lower movable plate 21, for example, by welding. Here, a pair of second inclined surfaces 42 is formed at predetermined locations on the upper surface of the guide bracket 40. The second inclined surfaces 42 are spaced apart from each other in the forward-and-rearward direction.

Specifically, the guide bracket 40 is located on the outer side of the lower bearing 30 and is arranged in the forward-and-rearward direction. The front and rear ends of the guide bracket 40 are bent inwards and mounted on the outer surface of the lower movable plate 21, for example, by welding. Further, a pair of second inclined surfaces 42 is formed at predetermined locations on the upper surface of the guide bracket 40. The second inclined surfaces 42 are spaced apart from each other in the forward-and-rearward direction.

Preferably, the pair of first inclined surfaces 22 formed on the lower movable plate 21 and the pair of second inclined surfaces 42 formed on the guide bracket 40 are aligned with each other in the width direction and are formed to have the same inclination angle. The bearing guide pin may be horizontally oriented when supported by the pair of first inclined surfaces and the pair of second inclined surfaces.

A pair of upper bearings 50 is in close contact with the upper plate 12 of the lower rail 10 and is movable along the upper plate 12, and bearing guide pins 52 are coaxially installed in the central portions of the upper bearings 50. In this case, each of the bearing guide pins 52 serves as a support shaft.

Therefore, both ends of the bearing guide pin 52, coaxially installed in the upper bearing 50, may be movably seated on the first inclined surface 22 formed on the lower movable plate 21 and the second inclined surface 42 formed on the guide bracket 40, respectively.

In this case, one of the pair of first inclined surfaces 22 formed on the lower movable plate 21 (for example, the front one) is formed to be inclined downwards toward the front side, and the other (for example, the rear one) is formed to be inclined downwards toward the rear side.

In the same manner, one of the pair of second inclined surfaces 42 formed on the guide bracket 40 (for example, the front one) is formed to be inclined downwards toward the front side, and the other (the rear one) is formed to be inclined downwards toward the rear side.

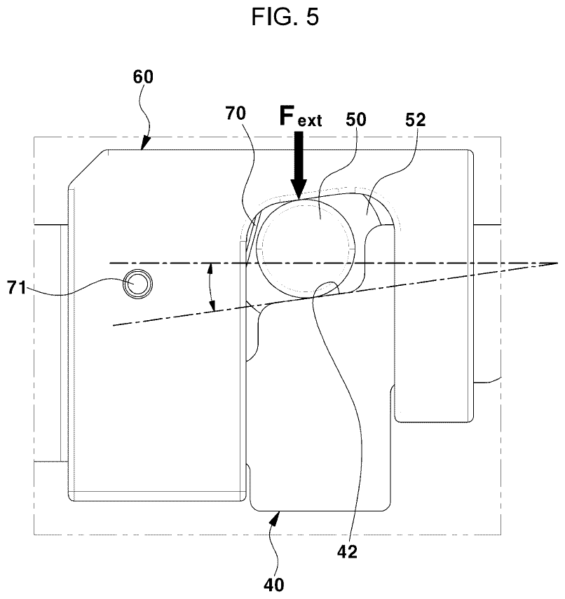

Preferably, as shown in FIG. 5, each of the inclination angles of the first inclined surface 22 and the second inclined surface 42 may range from 5° to 6° to apply gravitation force on the bearing guide pin 52 to thereby prevent the bearing guide pin 52 from being separated from each of the inclined surfaces 22 and 42. More preferably, each of the inclination angles of the first inclined surface 22 and the second inclined surface 42 may be formed to be 5°.

Meanwhile, a spring guide 60 is mounted in the rail space 13 surrounded in part by the lower movable plate 21 and the guide bracket 40, and a restoring spring 70 is mounted therebetween. In this case, the restoring springs 70 are mounted on the spring guide 60 and are in close contact with the bearing guide pin 52, thereby enabling the restoring springs 70 to apply elastic pressure laterally to both terminal portions of the bearing guide pin 52.

To this end, the spring guide 60 may be formed of an upper plate 61 seated on the upper surfaces of the lower movable plate 21 and the guide bracket 40, and a side plate 62 formed to extend downwards from opposite ends of the upper plate 61 for mounting of the restoring spring 70. Here, one of the opposite ends is coupled to the lower movable plate 21, and the other is coupled to the guide bracket 40.

Furthermore, as shown in FIG. 3, the side plate 62 of the spring guide 60 has an elastic hook 63 formed on the lower end thereof and inserted into and coupled to a coupling groove 23 formed in the lower inner surface of the lower movable plate 21 or caught by and coupled to the bottom surface of the guide bracket 40.

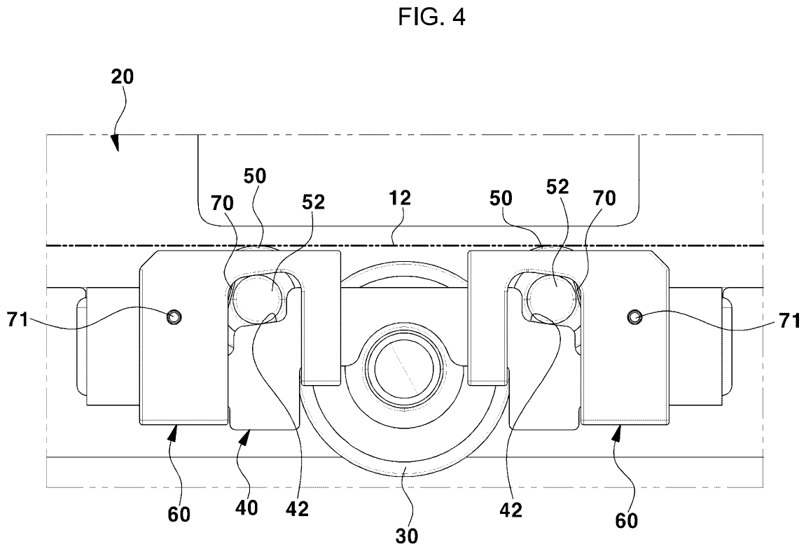

Additionally, as shown in FIG. 4, the side plate 62 of the spring guide 60 has a cutout portion 64 formed to be concave upwards and configured to prevent interference with the terminal portions of the bearing guide pin 52 or between the spring guide 60 and the bearing guide pin 52 movably mounted on the first and second inclined surfaces 22 and 42.

In detail, when the opposite ends of the bearing guide pin 52 are moved along the first inclined surface 22 and the second inclined surface 42, contact interference with the opposite ends of the bearing guide pin 52 may hinder forward-and-rearward movement of the bearing guide pin 52. To address this problem, the cutout portion 64 is formed to be concave upwards in the side plate 62 of the spring guide 60 to avoid contact interference with the opposite ends of the bearing guide pin 52.

Furthermore, a bearing exposure hole 65 is formed through the upper plate 61 of the spring guide 60. The bearing exposure hole 65 enables the upper end of the upper bearing 50 to protrude and contact the upper plate 12 of the lower rail 10.

Accordingly, in a state in which the opposite ends of the bearing guide pin 52, coaxially installed in the upper bearing 50, are respectively seated on the first inclined surface 22 and the second inclined surface 42, the upper end of the upper bearing 50 may pass through the bearing exposure hole 65 in the spring guide 60 and may slidably movably contact the upper plate 12 of the lower rail 10.

Meanwhile, the restoring spring 70 is mounted on the side plate 62 of the spring guide 60 and is in close contact with the bearing guide pin 52 to provide elastic pressure to the bearing guide pin 52.

To this end, one end of the restoring spring 70 is connected to a spring pin 71 fixed to the inner surface of the side plate 62 of the spring guide 60, and the other end thereof is in close contact with the bearing guide pin 52 to provide elastic pressure to the bearing guide pin 52.

Preferably, the restoring spring 70 may be a plate spring. One end of the plate spring is connected to the spring pin 71 fixed to the inner surface of the side plate 62 of the spring guide 60, and the other end of the plate spring is bent to have elastic restoring force and is in close contact with the bearing guide pin 52. In this manner, elastic pressure of the plate spring is applied to the upper bearing 50 via the bearing guide pin 52.

Meanwhile, in addition to elastic pressure of the restoring spring 70 applied to the bearing guide pin 52, coaxially installed in the upper bearing 50, in order to prevent the bearing guide pin 52 from being separated from the first inclined surface 22 formed on the lower movable plate 21 of the upper rail 20 and the second inclined surface 42 formed on the guide bracket 40, as shown in FIG. 5, the inclination angle of the first inclined surface 22 and the inclination angle of the second inclined surface 42 may be set to an optimal angle of 5° to 6° in consideration of vertical load and coefficient of static friction when a passenger sits on the seat. Preferably, the inclination angle of the first inclined surface 22 and the inclination angle of the second inclined surface 42 may be set to 5°.

For example, referring to FIG. 7, the inclination angle of the first inclined surface 22 and the inclination angle of the second inclined surface 42 are each set to α°, force (for example, vertical load) applied to the bearing guide pin 52 is set to Fₑₓₜ, force applied to the first inclined surface 22 and the second inclined surface 42 by the bearing guide pin 52 is set to FN=Fₑₓₜ×cos α°, force exerted by the bearing guide pin 52 along the first inclined surface 22 and the second inclined surface 42 is set to F_{S}=Fₑₓₜ×sin α°, frictional force of the bearing guide pin 52 against the first inclined surface 22 and the second inclined surface 42 is set to F_{μ}=F_{N}×μ_{static}, and the coefficient of static friction (μ_{static}) for the first inclined surface 22 and the second inclined surface 42 is set to a preset value of 0.1.

Therefore, when F_{S}=Fₑₓₜ×sin α°≥F_{μ}=F_{N}×μ_{static}, each of the inclination angle of the first inclined surface 22 and the inclination angle of the second inclined surface 42 may be determined to be 5.7° through the following mathematical process.

Fₑₓₜ×cosα°×μ_{static}≥Fₑₓₜ×sin α°

→μ_{static}≥sin α°/cos α°

→μ_{static}≥tan α°

→tan α°≤μ_{static}

→α°≤5.7

As described above, the inclination angle of the first inclined surface 22 and the inclination angle of the second inclined surface are each set 42 to the optimal angles of 5° to 6° and are each preferably set to 5°. Accordingly, even if vertical load is applied to the bearing guide pin 52 when a passenger sits on the seat, it is possible to completely prevent the bearing guide pin 52 from being separated from the first inclined surface 22 and the second inclined surface 42.

Here, an operation flow of the rail device of the present disclosure configured as described above will be described as follows.

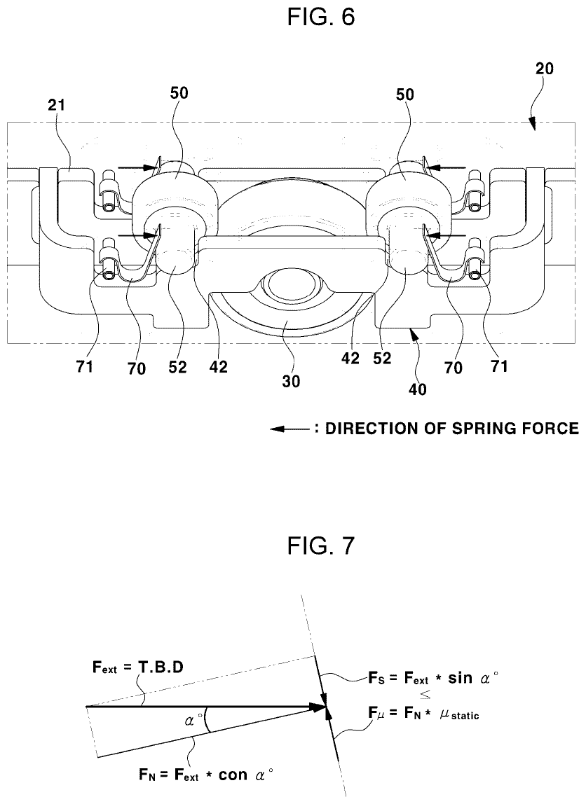

FIG. 6 is a perspective view of main portions, showing a direction of elastic pressure applied by the restoring spring of the vehicle seat rail device according to the present disclosure.

Referring to FIG. 6, in a state in which one end of the restoring spring 70 is connected to the spring pin 71, the other end of the restoring spring 70 is brought into close contact with the bearing guide pin 52 such that elastic pressure of the restoring spring 70 is applied to the upper bearing 50 via the bearing guide pin 52.

Therefore, the bearing guide pin 52 is pushed by the elastic pressure of the restoring spring 70 and is pushed up to the highest positions of the first inclined surface 22 formed on the lower movable plate 21 and the second inclined surface 42 formed on the guide bracket 40.

Furthermore, when the bearing guide pin 52 is pushed up to the highest positions of the first inclined surface 22 and the second inclined surface 42, the pair of upper bearings 50 may also be pushed along the same trajectory such that each of the upper bearings is in contact with the lower bearing 30.

Furthermore, the lower bearing 30 is in close contact the lower plate 11 of the lower rail 10 and is slidably movable along the lower plate 11, and the pair of upper bearings 50 is in close contact with the upper plate 12 of the lower rail 10 and is slidably movable along the upper plate 12.

In this state, when the upper rail 20 is moved forwards or rearwards to adjust the position of the seat in the forward-and-rearward direction, the lower bearing 30 is moved along the lower plate 11 of the lower rail 10, and simultaneously, the upper bearing 50 is moved along the upper plate 12 of the lower rail 10.

In this case, when vertical load applied to the upper bearing 50 varies depending on dimensional deviation of the lower rail 10 and the seat position of a passenger, the bearing guide pin 52 coaxially installed in the upper bearing 50 compresses the restoring spring 70 and is pushed downwards to the lower portions of the first inclined surface 22 and the second inclined surface 42, or is pushed upwards to the upper portions of the first inclined surface 22 and the second inclined surface 42 by elastic restoring force of the restoring spring 70.

Thus, even if the vertical load applied to the upper bearing 50 varies depending on the dimensional deviation of the lower rail 10 and the seat position of the passenger, the bearing guide pin 52 is pushed downwards to the lower portions of the first and second inclined surfaces 22 and 42, or is pushed upwards to the upper portions of the first and second inclined surfaces 22 and 42. As a result, the lower bearing 30 may be easily slidably moved along the lower plate 11 of the lower rail 10, and the upper bearing 50 may also be easily slidably moved along the upper plate 12 of the lower rail 10.

Furthermore, as a vertical clearance control function of the upper bearing 50, the bearing guide pin 52 coaxially installed in the upper bearing 50 is movably seated on the first inclined surface 22 and the second inclined surface 42, and elastic pressure of the restoring spring 70 is applied to the bearing guide pin 52. Accordingly, regardless of load applied to the lower rail 10 via the upper rail 20 when a passenger sits on the seat and dimensional deviation of the lower rail 10, the upper bearing 50 is kept in close contact with the upper plate 12 of the lower rail 10 and is movable along the upper plate 12 without any clearance between the upper bearing 50 and the upper plate 12.

Additionally, in a state in which the upper bearing 50 is brought into contact with the lower bearing 30 by elastic pressure of the restoring spring 70 applied to the upper bearing 50 via the bearing guide pin 52, the upper end of the upper bearing 50 is brought into close contact with the upper plate 12 of the lower rail 10, thereby enabling the upper end of the upper bearing 50 to be kept in contact with the upper plate 12 of the lower rail 10 without any clearance between the upper bearing 50 and the upper plate 12.

Furthermore, since the upper bearing 50 is kept in close contact with the upper plate 12 of the lower rail 10 without any clearance therebetween and is movable along the upper plate 12 by elastic pressure of the restoring spring 70 applied to the bearing guide pin 52, a difference between operating force for forward movement of the seat and operating force for rearward movement of the seat may be eliminated, and satisfaction of a passenger sitting on the seat may be maximally increased through reliable control of forward-and-rearward movement of the seat.

As is apparent from the above description, the present disclosure provides the following effects.

First, as a vertical clearance control function of an upper bearing, a bearing guide pin coaxially installed in the upper bearing is movably seated on a first inclined surface of a lower movable plate and a second inclined surface of a guide bracket, and elastic pressure of a restoring spring is applied to the bearing guide pin, thereby having an effect of enabling the upper bearing to be kept in contact with an upper plate of a lower rail and to be moved along the upper plate regardless of load applied to the lower rail via an upper rail when a passenger sits on a seat and dimensional deviation of the lower rail.

Second, the upper bearing is kept in close contact with the upper plate of the lower rail and is movable along the upper plate by elastic pressure of the restoring spring applied to the bearing guide pin, thereby having an effect of eliminating a difference between operating force for forward movement of the seat and operating force for rearward movement of the seat and maximally increasing satisfaction of a passenger sitting on the seat through reliable control of forward-and-rearward movement of the seat.

Third, in addition to elastic pressure of the restoring spring applied to the bearing guide pin coaxially installed in the upper bearing, in order to prevent the bearing guide pin from being separated from the first inclined surface formed on the lower movable plate of the upper rail and the second inclined surface formed on the guide bracket, an inclination angle of the first inclined surface and an inclination angle of the second inclined surface may each be set to an optimal angle (for example, 5° to 6°) in consideration of vertical load and coefficient of static friction when a passenger sits on the seat, thereby having an effect of completely preventing the bearing guide pin from being separated from the first and second inclined surfaces.

Although embodiments of the present disclosure have been described in detail above, the scope of the present disclosure is not limited to the above-described embodiments, and various modifications and improvements made by those skilled in the art using the basic concept defined in the following claims also fall within the scope of rights of the present disclosure.

What is claimed is:

1. A vehicle seat rail device comprising:
a lower rail having a lower plate and an upper plate integrally connected to each other, the lower plate and the upper plate forming a rail space;
an upper rail movably arranged along the lower rail, the upper rail including a lower movable plate formed at a lower portion of the upper rail and arranged within the rail space, the lower movable plate including a pair of first inclined surfaces formed on an upper portion thereof, the first inclined surfaces formed on the upper portion spaced apart from each other;
a lower bearing mounted on an outer surface of the lower movable plate and movably seated on the lower plate of the lower rail;
a guide bracket including a pair of second inclined surfaces formed on an upper portion thereof, the second inclined surfaces formed spaced apart from each other, the guide bracket mounted on the outer surface of the lower movable plate;
an upper bearing in close contact with the upper plate of the lower rail, the upper bearing being movable along the upper plate of the lower rail;
a bearing guide pin coaxially installed in the upper bearing and including terminal portions configured to be seated on the first inclined surface and the second inclined surface, respectively; and
restoring springs mounted inside the rail space, wherein the restoring springs are in close contact with the terminal portions of the bearing guide pin and are configured to apply elastic pressure laterally against the terminal portions of the bearing guide pin.

2. The vehicle seat rail device of claim 1, wherein the pair of first inclined surfaces formed on the lower movable plate and the pair of second inclined surfaces formed on the guide bracket are aligned with each other in a width direction and are formed to have the same inclination angle and the bearing guide pin is configured to be horizontally oriented when supported by the pair of first inclined surfaces and the pair of second inclined surfaces.

3. The vehicle seat rail device of claim 2, wherein the inclination angles of the first and second inclined surfaces range from 5°to 6°to apply gravitational force on the bearing guide pin thereby preventing the bearing guide pin from being separated from the first and second inclined surfaces.

4. The vehicle seat rail device of claim 2, wherein one of the pair of first inclined surfaces formed on the lower movable plate is formed to be inclined downwards toward a front side, and the other is formed to be inclined downwards toward a rear side.

5. The vehicle seat rail device of claim 2, wherein one of the pair of second inclined surfaces formed on the guide bracket is formed to be inclined downwards toward a front side, and the other is formed to be inclined downwards toward a rear side.

6. The vehicle seat rail device of claim 1, wherein a spring guide is mounted in the rail space, and the restoring springs are mounted on the spring guide so as to apply elastic pressure to the terminal portions of the bearing guide pin and are in close contact with the terminal portions of the bearing guide pin.

7. The vehicle seat rail device of claim 6, wherein the spring guide comprises:
an upper plate seated on upper surfaces of the lower movable plate and the guide bracket; and
a side plate formed to extend downwards from opposite ends of the upper plate for mounting of the restoring springs, wherein one of the opposite ends is coupled to the lower movable plate, and the other is coupled to the guide bracket.

8. The vehicle seat rail device of claim 7, wherein the side plate includes an elastic hook formed on a lower end thereof, the elastic hook configured to be inserted into and coupled to a coupling groove formed in a lower portion of the lower movable plate or be caught by and coupled to a bottom surface of the guide bracket.

9. The vehicle seat rail device of claim 7, wherein the side plate includes an interference-preventing cutout portion configured to prevent interference with the terminal portions of the bearing guide pin, respectively mounted on the first inclined surface and the second inclined surface.

10. The vehicle seat rail device of claim 7, wherein the spring guide includes a bearing exposure hole formed in the upper plate thereof, the bearing exposure hole configured to allow an upper end of the upper bearing to protrude and contact the upper plate of the lower rail.

11. The vehicle seat rail device of claim 7, wherein each of the restoring springs is a plate spring, wherein one end of the plate spring is connected to a spring pin fixed to the side plate of the spring guide on an inner surface thereof, and the other end of the plate spring is in close contact with the bearing guide pin to provide the elastic pressure to the bearing guide pin.
